(19) United States
(12) Patent Application Publication
(10) Pub. No.: US 2025/0273653 A1
(43) Pub. Date: Aug. 28, 2025

(54) NEGATIVE ELECTRODE FOR SECONDARY BATTERY, AND SECONDARY BATTERY

(71) Applicant: MURATA MANUFACTURING CO., LTD., Kyoto (JP)

(72) Inventor: Naoki HAYASHI, Kyoto (JP)

(21) Appl. No.: 19/207,764

(22) Filed: May 14, 2025

Related U.S. Application Data
(63) Continuation of application No. PCT/JP2023/043697, filed on Dec. 6, 2023.

(30) Foreign Application Priority Data
Jan. 13, 2023 (JP) 2023-003612

(51) Int. Cl. H01M 4/36; H01M 4/02; H01M 4/38; H01M 4/583; H01M 4/62; H01M 10/0525

(52) U.S. Cl. CPC H01M 4/364; H01M 4/386; H01M 4/583; H01M 4/621; H01M 4/625; H01M 10/0525; H01M 2004/021; H01M 2004/027

(57) ABSTRACT

A secondary battery is provided and includes a positive electrode, a negative electrode, and an electrolytic solution. The negative electrode includes a negative electrode active material, a negative electrode binder, and a negative electrode conductor. The negative electrode active material includes a silicon-containing material. The negative electrode binder includes an N-vinylacetamide polymer. The negative electrode conductor includes a fibrous carbon material. Based on an analysis of the negative electrode conductor by Raman spectroscopy, an absorption peak is detectable within a range of a Raman shift of greater than or equal to 120 cm⁻¹ and less than or equal to 300 cm⁻¹, and the absorption peak has a half-width of 10 cm⁻¹ or greater.

### CROSS REFERENCE TO RELATED APPLICATIONS

The present application is a continuation of International Application No. PCT/JP2023/043697, filed on Dec. 6, 2023, which claims priority to Japanese Patent Application No. 2023-003612, filed on Jan. 13, 2023, the entire contents of which are incorporated herein by reference.

### BACKGROUND

The present technology relates to a negative electrode for a secondary battery, and a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode (a negative electrode for a secondary battery), and an electrolytic solution. A configuration of the secondary battery has been considered in various ways.

Specifically, a negative electrode includes two negative electrode active materials and a binder (a polymer including an amide structure unit), and a mass ratio between the two negative electrode active materials is defined. A first one of the two negative electrode active materials includes a carbon material. A second one of the two negative electrode active materials includes a material that includes an element which lithium ions are insertable into and extractable from and is other than the carbon material.

### SUMMARY

The present technology relates to a negative electrode for a secondary battery, and a secondary battery.

Although consideration has been given in various ways regarding a configuration of a secondary battery, a battery characteristic of the secondary battery is not sufficient yet. Accordingly, there is room for improvement in terms of the battery characteristic of the secondary battery.

It is therefore desirable to provide a negative electrode for a secondary battery, and a secondary battery that each make it possible to achieve a superior battery characteristic.

A negative electrode for a secondary battery according to an embodiment of the present technology includes a negative electrode active material, a negative electrode binder, and a negative electrode conductor. The negative electrode active material includes a silicon-containing material. The negative electrode binder includes an N-vinylacetamide polymer. The negative electrode conductor includes a fibrous carbon material. Based on an analysis of the negative electrode conductor by Raman spectroscopy, an absorption peak is detectable within a range of a Raman shift of greater than or equal to 120 cm⁻¹ and less than or equal to 300 cm⁻¹ The absorption peak has a half-width of 10 cm⁻¹ or greater.

A secondary battery according to an embodiment of the present technology includes a positive electrode, a negative electrode, and an electrolytic solution. The negative electrode has a configuration similar to the above-described configuration of the negative electrode for the secondary battery according to an embodiment of the present technology.

As used herein, the “silicon-containing material” refers to a material including silicon as a constituent element, and the “N-vinylacetamide polymer” refers to a homopolymer of N-vinylacetamide, a copolymer of N-vinylacetamide, or both. Details of each of the silicon-containing material and the N-vinylacetamide polymer will be described later.

Further, the “half-width” refers to what is called a full width at half maximum (FWHM). Details of the half-width will be described later.

According to the negative electrode for the secondary battery or the secondary battery of an embodiment of the present technology: the negative electrode for the secondary battery includes the negative electrode active material, the negative electrode binder, and the negative electrode conductor; the negative electrode active material includes the silicon-containing material; the negative electrode binder includes the N-vinylacetamide polymer; the negative electrode conductor includes the fibrous carbon material; and based on the analysis of the negative electrode conductor by the Raman spectroscopy, the absorption peak detectable within the range of the Raman shift of greater than or equal to 120 cm⁻¹ and less than or equal to 300 cm⁻¹ has the half-width of 10 cm⁻¹ or greater. This makes it possible to achieve a superior battery characteristic.

Note that effects of the present technology are not necessarily limited to those described herein and may include any of a series of effects described below in relation to the present technology.

### BRIEF DESCRIPTION OF THE FIGURES

FIG. 1 is a sectional diagram illustrating a configuration of a negative electrode for a secondary battery according to an embodiment of the present technology.

FIG. 2 is a diagram illustrating an example of a result of an analysis of a negative electrode conductor by Raman spectroscopy.

FIG. 3 is a perspective diagram illustrating a configuration of a secondary battery according to an embodiment of the present technology.

FIG. 4 is a sectional diagram illustrating, in an enlarged manner, a configuration of a battery device illustrated in FIG. 3.

FIG. 5 is a block diagram illustrating a configuration of an application example of the secondary battery.

FIG. 6 is a sectional diagram illustrating a configuration of a test secondary battery.

### DETAILED DESCRIPTION

The present technology is described below in further detail including with reference to the drawings according to an embodiment.

A description is given first of a negative electrode for a secondary battery (hereinafter, simply referred to as a “negative electrode”) according to an embodiment of the present technology.

The negative electrode to be described here is to be used in a secondary battery, which is an electrochemical device. However, the negative electrode may be used in electrochemical devices other than the secondary battery. Specific examples of the other electrochemical devices include a primary battery and a capacitor.

The negative electrode allows an electrode reactant to be inserted into and extracted from the negative electrode upon an operation (an electrode reaction). Although not particularly limited in kind, the electrode reactant is specifically a light metal such as an alkali metal or an alkaline earth metal. Specific examples of the alkali metal include lithium, sodium, and potassium. Specific examples of the alkaline earth metal include magnesium and calcium.

The following description deals with an example case where the electrode reactant is lithium. Lithium is thus inserted into and extracted from the negative electrode in an ionic state upon the electrode reaction.

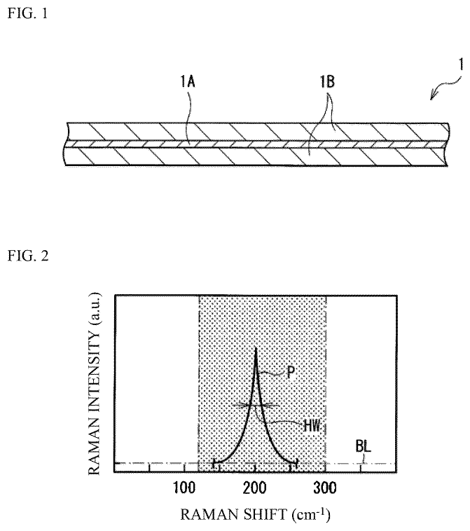

FIG. 1 illustrates a sectional configuration of a negative electrode 1 as an example of the negative electrode. The negative electrode 1 includes, as illustrated in FIG. 1, a negative electrode current collector 1A and a negative electrode active material layer 1B.

The negative electrode current collector 1A has two opposed surfaces on each of which the negative electrode active material layer 1B is to be provided. The negative electrode current collector 1A includes an electrically conductive material such as a metal material. Specific examples of the electrically conductive material include copper.

A surface of the negative electrode current collector 1A is preferably roughened. One reason for this is that adherence of the negative electrode active material layer 1B to the negative electrode current collector 1A is improved by what is called an anchor effect. A method of the roughening is not particularly limited, and is specifically a method in which microparticles are formed on a surface of a metal foil through an electrolytic treatment. The electrolytic treatment is a method of providing asperities on the surface of the metal foil by forming the microparticles on the surface of the metal foil by an electrolytic method in an electrolyzer.

The negative electrode active material layer 1B includes a negative electrode active material, a negative electrode binder, and a negative electrode conductor.

Here, the negative electrode active material layer 1B is provided on each of the two opposed surfaces of the negative electrode current collector 1A. Note, however, that the negative electrode active material layer 1B may be provided only on one of the two opposed surfaces of the negative electrode current collector 1A. A method of forming the negative electrode active material layer 1B is not particularly limited, and specific examples thereof include a coating method.

The negative electrode active material is a material which lithium is to be inserted into and extracted from. The negative electrode active material includes any one or more of silicon-containing materials. One reason for this is that a high energy density is obtainable owing to superior lithium insertability and superior lithium extractability of silicon.

The “silicon-containing material” refers to a material that includes silicon as a constituent element, as described above. That is, the silicon-containing material may be a simple substance of silicon, a silicon alloy, a silicon compound, a mixture of two or more thereof, or a material including two or more phases thereof. Note that the silicon-containing material is not particularly limited in state. Specifically, the silicon-containing material may be a solid solution, a eutectic (a eutectic mixture), an intermetallic compound, or in a state including two or more thereof that coexist.

The simple substance of silicon refers to a simple substance merely in a general sense. The simple substance of silicon may thus include a small amount of impurity. In other words, purity of the simple substance of silicon is not limited to 100%.

The silicon alloy is not particularly limited in kind. The silicon alloy specifically includes, as one or more constituent elements other than silicon, any one or more of metal elements including, without limitation, tin, nickel, copper, iron, cobalt, manganese, zinc, indium, silver, titanium, germanium, bismuth, antimony, and chromium.

Note that the silicon alloy is not limited to a material including one or more metal elements as one or more constituent elements, but may also encompass a material including one or more metal elements and one or more metalloid elements as constituent elements. The silicon alloy may further include one or more non-metallic elements as one or more constituent elements.

The silicon compound is not particularly limited in kind. Specifically, the silicon compound includes, as one or more constituent elements other than silicon, any one or more of non-metallic elements including, without limitation, oxygen and carbon. Note that the silicon compound may further include, as one or more constituent elements, any one or more of the above-described series of metal elements to be included in the silicon alloy as one or more constituent elements.

Specific examples of the silicon alloy and the silicon compound include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOₓ (where 0<x≤2 or 0.2<x<1.4), and LiSiO. Note that the composition of the specific example of each of the silicon alloy and the silicon compound is not limited to the above-described compositions, and may be changed as desired.

Here, when the silicon oxide (SiOₓ) is used as the silicon compound, an irreversible capacity tends to be great upon charging and discharging of the secondary battery including the negative electrode 1. To address this, when the silicon oxide is used as the silicon compound, the silicon oxide may be pre-doped with lithium. In other words, the silicon oxide may be doped with lithium in advance, in a state before the secondary battery is charged or discharged. One reason for this is that this suppresses a decrease in battery capacity to be caused by the irreversible capacity upon charging and discharging of the secondary battery.

Although the silicon-containing material is not particularly limited in crystal state, the silicon-containing material is preferably amorphous in particular. More specifically, it is preferable that, based on an analysis of the silicon-containing material by X-ray diffractometry (XRD), no crystalline peak be detected near a range of a diffraction angle 2θ from 28° to 29° both inclusive. One reason for this is that this suppresses formation of a side reaction product less contributing to the electrode reaction.

Note that a surface of the silicon-containing material may be covered with carbon. One reason for this is that this improves electrical conductivity of the negative electrode active material. In this case, all of the surface of the silicon-containing material may be covered with carbon, or only a part of the surface of the silicon-containing material may be covered with carbon.

Note that the negative electrode active material may further include any one or more of carbon materials. In other words, the negative electrode active material may include both the silicon-containing material and the carbon material. One reason for this is that this suppresses damage to the negative electrode active material layer 1B, while securing the battery capacity of the secondary battery including the negative electrode 1.

More specifically, while the silicon-containing material has an advantage of having a high theoretical capacity, there is a concern that the silicon-containing material easily and greatly expands and contracts upon charging and discharging. In contrast, while there is a concern that the carbon material has a low theoretical capacity, the carbon material has an advantage of being less prone to expansion and contraction upon charging and discharging. Thus, the combined use of the carbon material and the silicon-containing material suppresses expansion and contraction of the negative electrode active material layer 1B upon charging and discharging, while achieving a high theoretical capacity. This suppresses damage to the negative electrode active material layer 1B, while securing the battery capacity, as described above.

Specific examples of the carbon material include graphitizable carbon, non-graphitizable carbon, and graphite (natural graphite and artificial graphite).

When the negative electrode active material includes both the silicon-containing material and the carbon material, a mixture ratio between the silicon-containing material and the carbon material is not particularly limited. A weight proportion M, i.e., a proportion of a weight M1 of the silicon-containing material to a sum of the weight M1 of the silicon-containing material and a weight of the carbon material M2, is preferably 30 wt % or higher, in particular. One reason for this is that this further suppresses damage to the negative electrode active material layer 1B, while further improving the battery capacity of the secondary battery including the negative electrode 1. The weight proportion M is calculated based on the following calculation expression: weight proportion M= [M1/(M1+M2)]×100.

Although au upper limit of the weight proportion M is not particularly limited, the weight proportion M is preferably 70 wt % or lower, in particular. One reason for this is that this sufficiently and stably suppresses damage to the negative electrode active material layer 1B.

The negative electrode binder is a material that binds the materials including, without limitation, the negative electrode active material and the negative electrode conductor to each other. The negative electrode binder includes any one or more of N-vinylacetamide polymers. One reason for this is that this improves physical strength of the negative electrode active material layer 1B, and thus allows the negative electrode active material layer 1B to easily remain undamaged even if the electrode reaction is repeatedly performed. This suppresses occurrence of cracking of the negative electrode active material layer 1B, and also suppresses detachment of the negative electrode active material layer 1B from the negative electrode current collector 1A.

The “N-vinylacetamide polymer” refers to a homopolymer of N-vinylacetamide, a copolymer of N-vinylacetamide, or both, as described above. The homopolymer of N-vinylacetamide is what is called poly-N-vinylacetamide.

The copolymer of N-vinylacetamide is a compound in which N-vinylacetamide and one or more monomers other than N-vinylacetamide are copolymerized. The one or more monomers are not particularly limited in kind, and specific examples thereof include an acrylic acid, a methacrylic acid, an acrylic acid alkali metal salt, an acrylic acid alkaline earth metal salt, a methacrylic acid alkali metal salt, and a methacrylic acid alkaline earth metal salt.

Specific examples of the acrylic acid alkali metal salt include lithium acrylate, sodium acrylate, and potassium acrylate. Specific examples of the acrylic acid alkaline earth metal salt include calcium acrylate and magnesium acrylate. Specific examples of the methacrylic acid alkali metal salt include lithium methacrylate, sodium methacrylate, and potassium methacrylate. Specific examples of the methacrylic acid alkaline earth metal salt include calcium methacrylate and magnesium methacrylate.

A copolymerization amount of the one or more monomers in the copolymer of N-vinylacetamide is not particularly limited, and may be set as desired.

In particular, the copolymer of N-vinylacetamide preferably includes a copolymer of N-vinyl acetamide and the acrylic acid alkali metal salt. One reason for this is that this sufficiently improves the physical strength of the negative electrode active material layer 1B, and thus allows the negative electrode active material layer 1B to easily and sufficiently remain undamaged even when the electrode reaction is repeatedly performed.

The negative electrode conductor is a material that improves the electrical conductivity of the negative electrode active material layer 1B, and includes any one or more of fibrous carbon materials. One reason for this is that this makes it easier for particles of the negative electrode active material to be electrically coupled to each other via the negative electrode conductor, and thus makes it easier for an electrically conductive network to be formed inside the negative electrode active material layer 1B.

The one or more fibrous carbon materials are not particularly limited in kind, and specific examples thereof include a carbon nanotube.

In particular, the one or more fibrous carbon materials preferably include a single-walled carbon nanotube (SWCNT), and the single-walled carbon nanotube preferably has sufficiently high purity. One reason for this is that this makes it even easier for the electrically conductive network to be formed inside the negative electrode active material layer 1B, and thus sufficiently improves the electrical conductivity of the negative electrode active material layer 1B.

An average fiber diameter of the fibrous carbon material is not particularly limited, and is specifically 5 nm or smaller. A content of the negative electrode conductor (the one or more fibrous carbon materials) in the negative electrode active material layer 1B is not particularly limited, and is preferably 2 wt % or less, in particular. One reason for this is that this improves dispersibility of the negative electrode conductor in a process of manufacturing the negative electrode 1 (in a process of preparing a negative electrode mixture slurry) to be described later, and thus improves temporal stability of the negative electrode mixture slurry.

In particular, the negative electrode conductor including the one or more fibrous carbon materials has a predetermined physical property identifiable by an analysis of the negative electrode conductor by Raman spectroscopy. Note that details of the physical property of the negative electrode conductor will be described later with reference to FIG. 2.

Note that the negative electrode active material layer 1B may further include any one or more of other materials.

Specific examples of the other materials include another negative electrode active material. The other negative electrode active material includes any one or more of metal-based materials. Note that the silicon-containing material described above is excluded from the metal-based materials to be described here.

The metal-based material is a material including, as one or more constituent elements, any one or more elements among metal elements and metalloid elements that are each able to form an alloy with lithium. Specific examples of such metal elements and metalloid elements include tin. The metal-based material may be a simple substance, an alloy, a compound, a mixture of two or more thereof, or a material including two or more phases thereof.

Specific examples of the other materials also include another negative electrode binder. The other negative electrode binder includes a synthetic rubber, a polymer compound, or both. Note that the N-vinylacetamide polymer described above is excluded from the other negative electrode binder described here. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

In addition to the N-vinylacetamide polymer, a styrene-butadiene rubber, polyimide, and/or a carboxymethyl cellulose salt (a sodium salt, a potassium salt, or a lithium salt) are preferably added as the one or more other negative electrode binders. The addition of these one or more other negative electrode binders improves a cycle retention rate. Such improvement is achieved by improvement in property of maintaining an electron conductive network owing to an effect, derived from the styrene-butadiene rubber and polyimide, of increasing binding force between active material particles and a current collector foil. Such improvement is also achieved by improvement in the property of maintaining the electron conductive network in the active material, owing to the carboxymethyl cellulose salt serving as a dispersant to allow the carbon nanotubes to be further dispersed in the electrode. An amount of the addition of the styrene-butadiene rubber, polyimide, and/or the carboxymethyl cellulose salt is preferably within a range from 0.1 wt % to 10 wt % both inclusive, and is more preferably within a range from 0.2 wt % to 5 wt % both inclusive.

Specific examples of the other materials also include another negative electrode conductor. The other negative electrode conductor includes any one or more of a carbon material, a metal material, or an electrically conductive polymer compound. Note that the fibrous carbon material described above is excluded from the other negative electrode conductor described here. Specific examples of the carbon material include particles of a carbon material such as graphite, carbon black, acetylene black, or Ketjen black. Specific examples of the carbon material also include another fibrous carbon material such as a carbon fiber or a carbon nanofiber.

FIG. 2 illustrates an example of a result of an analysis of the negative electrode conductor by the Raman spectroscopy. In FIG. 2, a horizontal axis represents a Raman shift (cm⁻¹) and a vertical axis represents Raman intensity (a.u. (arbitrary unit)).

When the negative electrode conductor including the fibrous carbon material is analyzed by the Raman spectroscopy, a result (a Raman spectrum) of the analysis illustrated in FIG. 2 is obtainable. In this case, a predetermined physical property condition is satisfied in relation to the result of the analysis of the negative electrode conductor by the Raman spectroscopy.

Specifically, based on the analysis of the negative electrode conductor by the Raman spectroscopy, a Raman peak (an upward convex absorption peak P) having a vertex within a range of a Raman shift from 120 cm⁻¹ to 300 cm⁻¹ both inclusive is detectable. FIG. 2 applies shading to the range of the Raman shift from 120 cm⁻¹ to 300 cm⁻¹ both inclusive, and illustrates a case where one absorption peak P is detected.

The absorption peak P has a half-width HW of 10 cm⁻¹ or greater. Although an upper limit of the half-width HW is not particularly limited, specifically, the half-width HW is preferably 50 cm⁻¹ or less. The “half-width HW” refers to a full width at half maximum (FWHM), as described above. Specifically, the half-width HW is a width of the absorption peak P at a position corresponding to half a difference between a minimum value of the Raman intensity and a maximum value of the Raman intensity (=maximum value of Raman intensity-minimum value of Raman intensity), and the width of the absorption peak P corresponds to a difference between a minimum value of the Raman shift and a maximum value of the Raman shift (=maximum value of Raman shift-minimum value of Raman shift).

Note that the minimum value of the Raman intensity is determined based on a baseline BS, as indicated in FIG. 2. The baseline BL is a line segment along a substantially flat Raman spectrum in a case where such a substantially flat Raman spectrum is caused by the Raman intensity being minimum (substantially constant). In other words, the baseline BL is a line segment that extends substantially along the horizontal axis.

One reason why the physical property condition is satisfied in relation to the physical property of the negative electrode conductor including the fibrous carbon material (the result of the analysis of the negative electrode conductor by the Raman spectroscopy) is that the state of the negative electrode conductor is made appropriate. In this case, an electrically conductive network is formed using the negative electrode conductor even in a fine region between the particles of the negative electrode active material inside the negative electrode active material layer 1B, which markedly improves electron conductivity between the particles of the negative electrode active material. In addition, the electrically conductive network easily remains undamaged, even when the negative electrode active material layer 1B including the silicon-containing material expands and contracts due to the repeatedly performed electrode reaction. Accordingly, the electrical conductivity of the negative electrode active material layer 1B stably improves.

In particular, the fibrous carbon material preferably includes the single-walled carbon nanotube, as described above. One reason for this is that this allows the physical property condition to be easily satisfied in relation to the fibrous carbon material, and thus sufficiently improves the electrical conductivity of the negative electrode active material layer 1B, as described above.

However, whether the absorption peak P is detectable is considered to depend on purity of the single-walled carbon nanotube. Specifically, the absorption peak P is considered to be detectable when the purity of the single-walled carbon nanotube is sufficiently high, and the absorption peak P is considered to be undetectable when the purity of the single-walled carbon nanotube is not sufficiently high.

Details of a procedure for analyzing the negative electrode conductor by the Raman spectroscopy are as described below.

Used as an analyzer may be a Raman spectrometric apparatus such as RAMAN-11 available from Nanophoton. Upon analyzing, a laser beam (having a wavelength of 532 nm) and a spectrometer (600 gr/mm) are used, and an analysis range is so set that the entire negative electrode conductor to be analyzed is within the analysis range. Note that the half-width HW is calculable based on the Raman intensity of the absorption peak P with respect to the baseline BL, as described above.

Described in the following is a procedure for analyzing the negative electrode conductor in a case where a secondary battery including the negative electrode conductor is used for the analysis.

First, the secondary battery is disassembled to thereby take out the negative electrode 1. Thereafter, the negative electrode 1 is washed with a solvent for washing, to remove the electrolytic solution adhering to the negative electrode 1. The solvent for washing is not particularly limited in kind, and specifically includes any one or more of organic solvents (aprotic solvents) including, without limitation, a carbonic-acid-ester-based solvent, a ketone-based solvent, and an ester-based solvent. Note that when a film remains on the surface of the negative electrode 1, the negative electrode 1 may further be washed with an aqueous solvent such as water. Lastly, the negative electrode conductor included in the negative electrode 1 is analyzed by the Raman spectroscopy, as described above. It is thus checked whether the absorption peak P (having the half-width HW of 10 cm⁻¹ or greater) is detectable.

In checking whether the absorption peak P is detectable, the procedure for checking whether the absorption peak P is detectable may be repeated multiple times to improve detection accuracy of the absorption peak P. In this case, to improve calculation accuracy of the half-width HW, the procedure for calculating the half-width HW may be repeated multiple times, and an average value of the calculated values may be used as the half-width HW.

Note that FIG. 2 illustrates the case where one absorption peak P is detected, as described above. However, a combined peak is sometimes detected. The combined peak is a peak in which two or more absorption peaks P are combined with each other, and has two or more vertices within the range of the Raman shift from 120 cm⁻¹ to 300 cm⁻¹ both inclusive.

In this case, the combined peak is separated by an existing peak separation method to obtain two or more absorption peaks P, following which one absorption peak P that is the highest in Raman intensity (what is called a peak intensity) is selected among the two or more absorption peaks P, and the selected one absorption peak P is used as the absorption peak P for calculating the half-width HW.

Upon the electrode reaction of the negative electrode 1, in the negative electrode active material layer 1B, lithium is inserted into the negative electrode active material and lithium is extracted from the negative electrode active material. In this case, lithium is inserted and extracted in an ionic state.

The negative electrode 1 is manufactured by the following example procedure according to an embodiment.

First, the negative electrode active material including the silicon-containing material, the negative electrode binder including the N-vinylacetamide polymer, and the negative electrode conductor including the fibrous carbon material are mixed with each other to obtain a negative electrode mixture. In this case, the fibrous carbon material in which the above-described physical property condition is satisfied is used.

Thereafter, the negative electrode mixture is put into a solvent to thereby prepare a negative electrode mixture slurry in paste form. The solvent is an aqueous solvent such as ion-exchanged water.

Thereafter, the negative electrode mixture slurry is applied on the two opposed surfaces of the negative electrode current collector 1A to thereby form the negative electrode active material layers 1B. In this case, the negative electrode mixture slurry may be heated on an as-needed basis.

Lastly, the negative electrode active material layers 1B are compression-molded by, for example, a roll pressing machine. In this case, the negative electrode active material layers 1B may be heated. The negative electrode active material layers 1B may be compression-molded multiple times.

The negative electrode active material layers 1B are thus formed on the two respective opposed surfaces of the negative electrode current collector 1A. As a result, the negative electrode 1 is completed.

According to the negative electrode 1, the negative electrode 1 includes the negative electrode active material (the silicon-containing material), the negative electrode binder (the N-vinylacetamide polymer), and the negative electrode conductor (the fibrous carbon material), and the absorption peak P detectable based on the analysis of the negative electrode conductor by the Raman spectroscopy has the half-width HW of 10 cm⁻¹ or greater.

In this case, a series of kinds of action described below is achieved, as described above. Firstly, a high energy density is obtainable because the negative electrode active material includes the silicon-containing material. Secondly, the physical strength of the negative electrode active material layer 1B improves because the negative electrode binder includes the N-vinylacetamide polymer. This allows the negative electrode active material layer 1B to easily remain undamaged even when the electrode reaction is repeatedly performed. Thirdly, the negative electrode conductor includes the fibrous carbon material, and the physical property condition is satisfied in relation to the negative electrode conductor. This allows the electrically conductive network to be formed using the negative electrode conductor even in a fine region between the particles of the negative electrode active material inside the negative electrode active material layer 1B, and makes it easier for the electrically conductive network to remain undamaged even when the electrode reaction is repeatedly performed.

The electrical conductivity of the negative electrode active material layer 1B thus stably improves, which allows the battery characteristic of the secondary battery including the negative electrode 1 to improve. Accordingly, it is possible to achieve a secondary battery having a superior battery characteristic by using the negative electrode 1.

In particular, the fibrous carbon material may include the single-walled carbon nanotube. This allows the physical property condition to be easily satisfied in relation to the negative electrode conductor. This sufficiently improves the electrical conductivity of the negative electrode material active layer 1B. Accordingly, it is possible to achieve higher effects.

Further, the negative electrode active material may further include the carbon material. This suppresses damage to the negative electrode active material layer 1B, while securing the battery capacity of the secondary battery including the negative electrode 1. Accordingly, it is possible to achieve higher effects.

In this case, the weight proportion of the silicon-containing material may be 30 wt % or higher. This further suppresses damage to the negative electrode active material layer 1B, while further improving the battery capacity of the secondary battery including the negative electrode 1. Accordingly, it is possible to achieve even higher effects.

A description is given next of a secondary battery according to an embodiment of the present technology to which the negative electrode 1 is applicable.

The secondary battery to be described here is a secondary battery in which a battery capacity is obtained through insertion and extraction of an electrode reactant, and includes a positive electrode, a negative electrode, and an electrolytic solution. The following description deals with an example case where the electrode reactant is lithium as described above. A secondary battery in which the battery capacity is obtained through insertion and extraction of lithium is what is called a lithium-ion secondary battery. In the lithium-ion secondary battery, lithium is inserted and extracted in an ionic state.

Note that a charge capacity of the negative electrode is preferably greater than a discharge capacity of the positive electrode. In other words, an electrochemical capacity per unit area of the negative electrode is preferably greater than an electrochemical capacity per unit area of the positive electrode. This is to prevent precipitation of lithium on a surface of the negative electrode during charging.

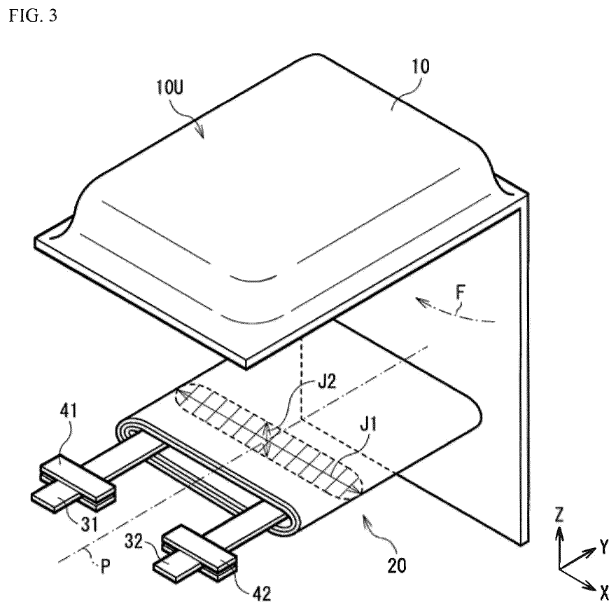

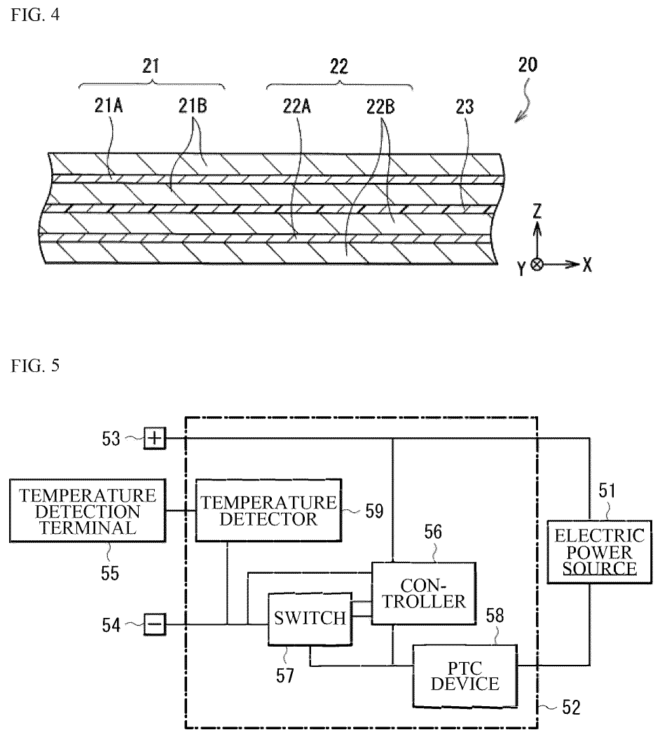

FIG. 3 illustrates a perspective configuration of the secondary battery. FIG. 4 illustrates, in an enlarged manner, a sectional configuration of a battery device 20 illustrated in FIG. 3. Note that FIG. 3 illustrates a state where an outer package film 10 and the battery device 20 are separated from each other, and a section of the battery device 20 along an XZ plane is indicated by a dashed line. FIG. 4 illustrates only a part of the battery device 20.

As illustrated in FIGS. 3 and 4, the secondary battery includes the outer package film 10, the battery device 20, a positive electrode lead 31, a negative electrode lead 32, and sealing films 41 and 42. The secondary battery described here is a secondary battery of a laminated-film type in which the outer package film 10 having flexibility or softness is used.

As illustrated in FIG. 3, the outer package film 10 is the outer package member that contains the battery device 20. The outer package film 10 has a pouch-shaped structure that is sealed in a state where the battery device 20 is contained inside the outer package film 10. The outer package film 10 thus contains a positive electrode 21, a negative electrode 22, and an electrolytic solution that are to be described later.

Here, the outer package film 10 is a single film-shaped member and is folded toward a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state where the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10, which is a laminated film, is not particularly limited in configuration or the number of layers, and may be single-layered or two-layered, or may include four or more layers.

As illustrated in FIGS. 3 and 4, the battery device 20 is a power generation device that includes the positive electrode 21, the negative electrode 22, a separator 23, and the electrolytic solution (not illustrated). The battery device 20 is contained inside the outer package film 10.

The battery device 20 is what is called a wound electrode body. Specifically, the positive electrode 21 and the negative electrode 22 are stacked on each other with the separator 23 interposed therebetween, and are wound about a winding axis Pin a state of being opposed to each other with the separator 23 interposed therebetween. The winding axis P is a virtual axis extending in a Y-axis direction.

The battery device 20 is not particularly limited in three-dimensional shape. Here, the battery device 20 has an elongated shape. Accordingly, a section of the battery device 20 intersecting the winding axis P, that is, a section of the battery device 20 along the XZ plane, has an elongated shape defined by a major axis J1 and a minor axis J2. The major axis J1 is a virtual axis that extends in an X-axis direction and has a length larger than a length of the minor axis J2. The minor axis J2 is a virtual axis that extends in a Z-axis direction intersecting the X-axis direction and has the length smaller than the length of the major axis J1. Here, the battery device 20 has an elongated cylindrical three-dimensional shape. Thus, the section of the battery device 20 has an elongated, substantially elliptical shape.

The positive electrode 21 includes, as illustrated in FIG. 4, a positive electrode current collector 21A and a positive electrode active material layer 21B.

The positive electrode current collector 21A has two opposed surfaces on each of which the positive electrode active material layer 21B is to be provided. The positive electrode current collector 21A includes an electrically conductive material such as a metal material. Specific examples of the electrically conductive material include aluminum.

Here, the positive electrode active material layer 21B is provided on each of the two opposed surfaces of the positive electrode current collector 21A. The positive electrode active material layer 21B includes any one or more of positive electrode active materials which lithium is insertable into and extractable from. Note that the positive electrode active material layer 21B may be provided only on one of the two opposed surfaces of the positive electrode current collector 21A on a side where the positive electrode 21 is opposed to the negative electrode 22. Further, the positive electrode active material layer 21B may further include any one or more of other materials including, without limitation, a positive electrode binder and a positive electrode conductor. A method of forming the positive electrode active material layer 21B is not particularly limited, and specifically includes a method such as a coating method.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table. The lithium-containing compound is not particularly limited in kind, and is specifically, for example, an oxide, a phosphoric acid compound, a silicic acid compound, and a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13}) O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The positive electrode conductor includes any one or more of electrically conductive materials including, without limitation, a carbon material, a metal material, and an electrically conductive polymer compound. Specific examples of the carbon material include graphite, carbon black, acetylene black, and Ketjen black.

The negative electrode 22 has a configuration similar to that of the above-described negative electrode 1. Specifically, the negative electrode 22 includes, as illustrated in FIG. 4, a negative electrode current collector 22A and a negative electrode active material layer 22B. The negative electrode current collector 22A has a configuration similar to that of the negative electrode current collector 1A. The negative electrode active material layer 22B has a configuration similar to that of the negative electrode active material layer 1B.

As illustrated in FIG. 4, the separator 23 is an insulating porous film interposed between the positive electrode 21 and the negative electrode 22 and allows lithium ions to pass therethrough while preventing contact (a short circuit) between the positive electrode 21 and the negative electrode 22. The separator 23 includes a polymer compound such as polyethylene.

The electrolytic solution is a liquid electrolyte. The positive electrode 21, the negative electrode 22, and the separator 23 are each impregnated with the electrolytic solution. The electrolytic solution includes a solvent and an electrolyte salt.

Here, the solvent includes any one or more of non-aqueous solvents (organic solvents), and the electrolytic solution including the non-aqueous solvent(s) is what is called a non-aqueous electrolytic solution. The non-aqueous solvent is, for example, an ester or an ether, more specifically, a carbonic-acid-ester-based compound, a carboxylic-acid-ester-based compound, or a lactone-based compound, for example. One reason for this is that a dissociation property of the electrolyte salt improves and ion mobility also improves.

The carbonic-acid-ester-based compound is a cyclic carbonic acid ester or a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include ethyl acetate, ethyl propionate, propyl propionate, and ethyl trimethylacetate. The lactone-based compound is, for example, a lactone. Specific examples of the lactone include γ-butyrolactone and γ-valerolactone. Note that the ether may be, for example, 1,2-dimethoxyethane, tetrahydrofuran, 1,3-dioxolane, or 1,4-dioxane.

The electrolyte salt includes any one or more of light metal salts including, without limitation, a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato) borate (LiB(C₂O₄)₂), lithium monofluorophosphate (Li₂PFO₃), and lithium difluorophosphate (LiPF₂O₂). One reason for this is that a high battery capacity is obtainable.

A content of the electrolyte salt is not particularly limited, and is specifically within a range from 0.3 mol/kg to 3.0 mol/kg both inclusive with respect to the solvent. One reason for this is that high ion conductivity is obtainable.

Note that the electrolytic solution may further include any one or more of additives. One reason for this is that electrochemical stability of the electrolytic solution improves. The additives are not particularly limited in kind, and specific examples thereof include an unsaturated cyclic carbonic acid ester, a fluorinated cyclic carbonic acid ester, a sulfonic acid ester, a phosphoric acid ester, an acid anhydride, a nitrile compound, and an isocyanate compound.

Specific examples of the unsaturated cyclic carbonic acid ester include vinylene carbonate, vinyl ethylene carbonate, and methylene ethylene carbonate. Specific examples of the fluorinated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

As illustrated in FIGS. 3 and 4, the positive electrode lead 31 is a positive electrode terminal coupled to the positive electrode current collector 21A of the positive electrode 21, and is led to an outside of the outer package film 10. The positive electrode lead 31 includes an electrically conductive material such as a metal material. Specific examples of the electrically conductive material include aluminum. The positive electrode lead 31 is not particularly limited in shape, and specifically has any of shapes including, without limitation, a thin plate shape and a meshed shape.

As illustrated in FIGS. 3 and 4, the negative electrode lead 32 is a negative electrode terminal coupled to the negative electrode current collector 22A of the negative electrode 22, and is led to the outside of the outer package film 10. The negative electrode lead 32 includes an electrically conductive material such as a metal material. Specific examples of the electrically conductive material include copper. Details of a direction in which the negative electrode lead 32 is led are similar to those of the direction in which the positive electrode lead 31 is led. Details of a shape of the negative electrode lead 32 are similar to those of the shape of the positive electrode lead 31.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry of, for example, outside air into the outer package film 10. Specifically, the sealing film 41 includes a polymer compound such as a polyolefin that has adherence to the positive electrode lead 31. Specific examples of the polyolefin include polypropylene.

The sealing film 42 has a configuration similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

The secondary battery operates as described below upon charging and discharging.

Upon charging, in the battery device 20, lithium is extracted from the positive electrode 21, and the extracted lithium is inserted into the negative electrode 22 via the electrolytic solution. Upon discharging, in the battery device 20, lithium is extracted from the negative electrode 22, and the extracted lithium is inserted into the positive electrode 21 via the electrolytic solution. Upon each of the charging and the discharging, lithium is inserted and extracted in an ionic state.

In a case of manufacturing the secondary battery, the positive electrode 21 and the negative electrode 22 are each fabricated, and the electrolytic solution is prepared, following which the secondary battery is assembled using the positive electrode 21, the negative electrode 22, and the electrolytic solution, and a stabilization process of the assembled secondary battery is performed, according to an example procedure to be described below.

First, a mixture (a positive electrode mixture) in which the positive electrode active material, the positive electrode binder, and the positive electrode conductor are mixed with each other is put into a solvent to thereby prepare a positive electrode mixture slurry in paste form. The solvent may be an aqueous solvent, or may be an organic solvent. Thereafter, the positive electrode mixture slurry is applied on the two opposed surfaces of the positive electrode current collector 21A to thereby form the positive electrode active material layers 21B. Lastly, the positive electrode active material layers 21B may be compression-molded by, for example, a roll pressing machine. In this case, the positive electrode active material layers 21B may be heated. The positive electrode active material layers 21B may be compression-molded multiple times. The positive electrode active material layers 21B are thus formed on the two respective opposed surfaces of the positive electrode current collector 21A. As a result, the positive electrode 21 is fabricated.

The negative electrode active material layers 22B are formed on the two respective opposed surfaces of the negative electrode current collector 22A by a procedure similar to the fabrication procedure of the negative electrode 1 described above to thereby fabricate the negative electrode 22.

The electrolyte salt is put into the solvent. The electrolyte salt is thereby dispersed or dissolved in the solvent. Thus, the electrolytic solution is prepared.

First, the positive electrode lead 31 is coupled to the positive electrode current collector 21A of the positive electrode 21 by a joining method such as a welding method, and the negative electrode lead 32 is coupled to the negative electrode current collector 22A of the negative electrode 22 by a joining method such as the welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body (not illustrated). Thereafter, the wound body is pressed by, for example, a pressing machine to thereby shape the wound body into an elongated shape. The wound body has a configuration similar to that of the battery device 20 except that the positive electrode 21, the negative electrode 22, and the separator 23 are each not impregnated with the electrolytic solution.

Thereafter, the wound body is placed inside the depression part 10U, following which the outer package film 10 (the fusion-bonding layer/the metal layer/the surface protective layer) is folded to thereby cause parts of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained inside the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by a bonding method such as the thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution. Thus, the battery device 20, i.e., the wound electrode body, is fabricated, and the battery device 20 is sealed in the outer package film 10 having the pouch shape. As a result, the secondary battery is assembled.

The assembled secondary battery is charged and discharged. Conditions including, for example, an environment temperature, the number of times of charging and discharging (the number of cycles), and charging and discharging conditions may be set as desired. As a result, a film is formed on the surface of each of the positive electrode 21 and the negative electrode 22, which electrochemically stabilizes a state of the battery device 20. The secondary battery is thus completed.

According to the foregoing secondary battery, the secondary battery includes the negative electrode 22, and the negative electrode 22 has a configuration similar to that of the negative electrode 1. Accordingly, the electrical conductivity of the negative electrode active material layer 22B stably improves for some reasons described above. It is therefore possible to achieve a superior battery characteristic.

In particular, the secondary battery may include a lithium-ion secondary battery. This makes it possible to obtain a sufficient battery capacity stably through insertion and extraction of lithium. Accordingly, it is possible to achieve higher effects.

Other action and effects of the secondary battery are similar to those of the negative electrode 1.

Next, a description is given of modification examples of the above-described secondary battery according to an embodiment.

The configuration of the secondary battery is appropriately modifiable as described below according to an embodiment. Note that any of the following series of modification examples may be combined with each other.

The separator 23 that is a porous film is used. However, although not specifically illustrated here, a separator of a stacked type including a polymer compound layer may be used.

Specifically, the separator of the stacked type includes a porous film having two opposed surfaces, and the polymer compound layer provided on one of or each of the two opposed surfaces of the porous film. One reason for this is that adherence of the separator to each of the positive electrode 21 and the negative electrode 22 improves, which suppresses winding displacement of the battery device 20. This suppresses swelling of the secondary battery even if a decomposition reaction of the electrolytic solution occurs. The polymer compound layer includes a polymer compound such as polyvinylidene difluoride. One reason for this is that polyvinylidene difluoride is superior in physical strength and is electrochemically stable.

Note that the porous film, the polymer compound layer, or both may each include insulating particles. One reason for this is that the insulating particles promote heat dissipation upon heat generation by the secondary battery, thus improving safety or heat resistance of the secondary battery. The insulating particles include any one or more of materials including, without limitation, an inorganic material and a resin material. Specific examples of the inorganic material include aluminum oxide, aluminum nitride, boehmite, silicon oxide, titanium oxide, magnesium oxide, and zirconium oxide. Specific examples of the resin material include acrylic resin and styrene resin.

When fabricating the separator of the stacked type, a precursor solution including the polymer compound and a solvent is prepared, following which the precursor solution is applied on one of or each of the two opposed surfaces of the porous film. In this case, the porous film may be immersed in the precursor solution instead of applying the precursor solution on the porous film. The insulating particles may be added to the precursor solution.

When the separator of the stacked type is used also, lithium is movable between the positive electrode 21 and the negative electrode 22, and similar effects are therefore achievable. In this case, in particular, the secondary battery improves in safety, as described above. Accordingly, it is possible to achieve higher effects.

The electrolytic solution that is a liquid electrolyte is used. However, although not specifically illustrated here, an electrolyte layer, which is a gel electrolyte, may be used.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23. Note that the electrolyte layer may be interposed only between the positive electrode 21 and the separator 23, or may be interposed only between the negative electrode 22 and the separator 23.

The electrolyte layer includes a polymer compound together with the electrolytic solution. The electrolytic solution is held by the polymer compound. One reason for this is that leakage of the electrolytic solution is prevented. The configuration of the electrolytic solution is as described above. The polymer compound includes, for example, polyvinylidene difluoride. When forming the electrolyte layer, a precursor solution including the electrolytic solution, the polymer compound, and a solvent is prepared, following which the precursor solution is applied on one side or both sides of the positive electrode 21 and on one side or both sides of the negative electrode 22.

When the electrolyte layer is used also, lithium is movable between the positive electrode 21 and the negative electrode 22 via the electrolyte layer, and similar effects are therefore achievable. In this case, in particular, the leakage of the electrolytic solution is prevented, as described above. Accordingly, it is possible to achieve higher effects.

Lastly, a description is given of applications (application examples) of the secondary battery.

The applications of the secondary battery are not particularly limited. The secondary battery used as a power source may serve as a main power source or an auxiliary power source of, for example, electronic equipment and an electric vehicle. The main power source is preferentially used regardless of the presence of any other power source. The auxiliary power source may be used in place of the main power source, or may be switched from the main power source.

Specific examples of the applications of the secondary battery include electronic equipment, apparatuses for data storage, electric power tools, battery packs, medical electronic equipment, electric vehicles, and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. The battery pack is to be mounted on, for example, electronic equipment. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery pack may include a battery cell, or may include an assembled battery. The electric vehicle is a vehicle that travels with the secondary battery as a driving power source, and may be a hybrid automobile that is additionally provided with a driving source other than the secondary battery. In an electric power storage system for home use, electric power accumulated in the secondary battery serving as an electric power storage source may be utilized for using home appliances.

An application example of the secondary battery will now be described in detail. The configuration described below is merely an example, and is appropriately modifiable.

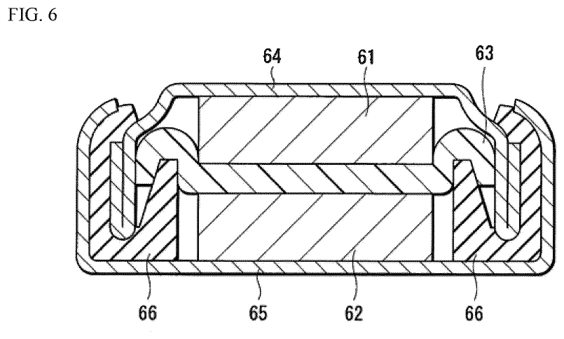

FIG. 5 illustrates a block configuration of a battery pack as the application example of the secondary battery. The battery pack described here is a battery pack (what is called a soft pack) including one secondary battery, and is to be mounted on, for example, electronic equipment typified by a smartphone.

As illustrated in FIG. 5, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to an external power source via the positive electrode terminal 53 and the negative electrode terminal 54, and is thus chargeable and dischargeable. The circuit board 52 includes a controller 56, a switch 57, a thermosensitive resistive device (what is called a PTC device) 58, and a temperature detector 59. However, the PTC device 58 may be omitted.

The controller 56 includes a central processing unit (CPU) and a memory, and controls an operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited and is specifically 4.20 V±0.05 V. The overdischarge detection voltage is not particularly limited and is specifically 2.40 V±0.10 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes a metal-oxide-semiconductor field-effect transistor (MOSFET). The charging and discharging currents are detected based on an ON-resistance of the switch 57.

The temperature detector 59 includes a temperature detection device such as a thermistor. The temperature detector 59 measures a temperature of the electric power source 51 through the temperature detection terminal 55, and outputs a result of the temperature measurement to the controller 56. The result of the temperature measurement to be obtained by the temperature detector 59 is used, for example, when the controller 56 performs charge and discharge control upon abnormal heat generation or when the controller 56 performs a correction process upon calculating a remaining capacity.

### EXAMPLES

A description is given of Examples of the present technology according to an embodiment.

### Experiment Examples 1 to 13 and Comparative Examples 1 to 6

Secondary batteries were fabricated, following which each of the secondary batteries was evaluated for its characteristic.

### [Fabrication of Secondary Battery]

The secondary batteries (the lithium-ion secondary batteries of the laminated-film type) illustrated in FIGS. 3 and 4 were fabricated in accordance with a procedure described below.

### [Fabrication of Positive Electrode]

First, 95 parts by mass of the positive electrode active material (lithium cobalt oxide (LiCoO₂) as a lithium-containing compound (an oxide)), 3 parts by mass of the positive electrode binder (polyvinylidene difluoride), and 2 parts by mass of the positive electrode conductor (Ketjen black as amorphous carbon powder) were mixed with each other to thereby obtain a positive electrode mixture. Thereafter, the positive electrode mixture was put into a solvent (N-methyl-2-pyrrolidone as an organic solvent), following which the solvent was stirred to thereby prepare a positive electrode mixture slurry in paste form.

Thereafter, the positive electrode mixture slurry was applied on the two opposed surfaces of the positive electrode current collector 21A (an aluminum foil having a thickness of 10 μm) by a coating apparatus, following which the applied positive electrode mixture slurry was dried by hot air to thereby form the positive electrode active material layers 21B.

Lastly, the positive electrode active material layers 21B were compression-molded by a roll pressing machine, following which the positive electrode current collector 21A on which the positive electrode active material layers 21B were formed was cut into a band shape (having a width of 70 mm and a length of 800 mm). The positive electrode 21 was thus fabricated.

### [Fabrication of Negative Electrode]

First, 94 parts by mass of the negative electrode active material (a mixture of a silicon-containing material and a carbon material, or the silicon-containing material), 5 parts by mass of the negative electrode binder (an N-vinylacetamide (NVA) polymer), 0.3 parts by mass of the negative electrode conductor (a single-walled carbon nanotube (SWCNT) as a fibrous carbon material), and 0.7 parts by mass of the other negative electrode conductor (carbon black as particles of a carbon material) were mixed with each other to thereby obtain a negative electrode mixture. Note that Tables 1 and 2 omit description of the other negative electrode conductor.

When the mixture of the silicon-containing material and the carbon material was used as the negative electrode active material, silicon oxide (SiOₓ) as a silicon compound was used as the silicon-containing material, and a mesocarbon microbead (MCMB) was used as the carbon material. When only the silicon-containing material was used as the negative electrode active material, a single substance of silicon (Si), a silicon-titanium alloy (SiTi_{0.01}) as a silicon alloy, or silicon oxide (SiO) as a silicon compound was used as the silicon-containing material. A mixture ratio (a content (wt %)) of the negative electrode active material was as listed in Tables 1 and 2.

Used as the negative electrode binder (the N-vinylacetamide polymer) was a homopolymer of N-vinylacetamide (poly-N-vinylacetamide (PNVA)) or a copolymer of N-vinylacetamide. Used as the copolymer of N-vinylacetamide was a copolymer of N-vinylacetamide and an acrylic acid alkali metal salt.

Used as the copolymer of N-vinylacetamide and the acrylic acid alkali metal salt was a copolymer of N-vinylacetamide and lithium acrylate (NVA-AALi), a copolymer of N-vinylacetamide and sodium acrylate (NVA-AANa), or a copolymer of N-vinylacetamide and potassium acrylate (NVA-AAK). A copolymerization amount of the monomer (lithium acrylate, sodium acrylate, or potassium acrylate) in the copolymer of N-vinylacetamide was set to 10 wt %.

In particular, when the mixture of the silicon-containing material and the carbon material was used as the negative electrode active material, a weight proportion (wt %) of the silicon-containing material was adjusted as indicated in Tables 1 and 2 by changing the mixture ratio between the silicon-containing material and the carbon material.

Further, as the other negative electrode binder, a styrene-butadiene rubber (SBR) was further added in Example 11, polyimide (PI) was further added in Example 12, and a carboxymethyl cellulose salt (CMCN) was further added in Example 13. A content (wt %) of each of the foregoing materials was as listed in Table 1.

Used as the negative electrode conductor was a fibrous carbon material (a single-walled carbon nanotube with high purity) that allowed for detection of the absorption peak P (having a half-width HW of 10 cm⁻¹ or greater) based on an analysis of the negative electrode conductor by the Raman spectroscopy.

Thereafter, the negative electrode mixture was put into a solvent (ion-exchanged water as an aqueous solvent), following which the solvent was kneaded and stirred by a planetary centrifugal mixer to thereby prepare a negative electrode mixture slurry in paste form.

Thereafter, the negative electrode mixture slurry was applied on the two opposed surfaces of the negative electrode current collector 22A (a copper foil having a thickness of 8 μm) by a coating apparatus, following which the applied negative electrode mixture slurry was dried by hot air to thereby form the negative electrode active material layers 22B.

Lastly, the negative electrode active material layers 22B were compression-molded by a roll pressing machine, following which the negative electrode current collector 22A on which the negative electrode active material layers 22B were formed was cut into a band shape (having a width of 72 mm and a length of 810 mm). The negative electrode 22 was thus fabricated.

The negative electrode 22 for comparison was fabricated by a similar procedure, except that a fibrous carbon material (a single-walled carbon nanotube with low purity) that did not allow for the detection of the absorption peak P (having the half-width HW of 10 cm⁻¹ or greater) was used as the negative electrode conductor, as indicated in Table 2. In the “absorption peak” column in each of Tables 1 and 2, “detected” indicates that the absorption peak P was detected, and “undetected” indicates that no absorption peak P was detected.

Further, the negative electrode 22 for comparison was fabricated by a similar procedure, except that a polyacrylic acid (PAA) was used as the negative electrode conductor, instead of the N-vinylacetamide polymer, as indicated in Table 2.

### [Preparation of Electrolytic Solution]

The electrolyte salt (lithium hexafluorophosphate (LiPF₆) as a lithium salt) was added to the solvent (ethylene carbonate as a cyclic carbonic acid ester, and ethyl methyl carbonate as a chain ethylene carbonate), following which the solvent was stirred. In this case, a mixture ratio (a mass ratio) between ethylene carbonate and ethyl methyl carbonate in the solvent was set to 50:50, and a content of the electrolyte salt was set to 1 mol/l (=1 mol/dm³) with respect to the solvent. The electrolytic solution was thus prepared.

### [Assembly of Secondary Battery]

First, the positive electrode lead 31 (an aluminum foil) was welded to the positive electrode current collector 21A of the positive electrode 21, and the negative electrode lead 32 (a copper foil) was welded to the negative electrode current collector 22A of the negative electrode 22.

Thereafter, the positive electrode 21 and the negative electrode 22 were stacked on each other with the separator 23 (a fine porous polyethylene film having a thickness of 25 μm) interposed therebetween, following which the stack of the positive electrode 21, the negative electrode 22, and the separator 23 was wound to thereby fabricate a wound body. Thereafter, the wound body was pressed by a pressing machine, and was thereby shaped into an elongated shape.

Thereafter, the outer package film 10 was so folded as to sandwich the wound body contained inside the depression part 10U. As the outer package film 10, an aluminum laminated film was used in which a fusion-bonding layer (a polypropylene film having a thickness of 30 μm), a metal layer (an aluminum foil having a thickness of 40 μm), and a surface protective layer (a nylon film having a thickness of 25 μm) were stacked in this order from an inner side. Thereafter, the outer edge parts of two sides of the fusion-bonding layer opposed to each other were thermal-fusion-bonded to each other to thereby allow the wound body to be contained inside the outer package film 10 having the pouch shape.

Lastly, the electrolytic solution was injected into the outer package film 10 having the pouch shape, following which the outer edge parts of the remaining one side of the fusion-bonding layer opposed to each other were thermal-fusion-bonded to each other in a reduced-pressure environment. In this case, the sealing film 41 (a polypropylene film having a thickness of 5 μm) was interposed between the outer package film 10 and the positive electrode lead 31, and the sealing film 42 (a polypropylene film having a thickness of 5 μm) was interposed between the outer package film 10 and the negative electrode lead 32.

The wound body was thereby impregnated with the electrolytic solution, and the battery device 20 was thus fabricated. Accordingly, the battery device 20 was sealed in the outer package film 10. As a result, the secondary battery was assembled.

### [Stabilization of Secondary Battery]

The secondary battery was charged and discharged for one cycle in an ambient temperature environment (at a temperature of 23° C.). Upon charging, the secondary battery was charged with a constant current of 0.2 C until a voltage reached 4.4 V, and was thereafter charged with a constant voltage of that value, 4.4 V, until a current reached 0.025 C. Upon discharging, the secondary battery was discharged with a constant current of 0.2 C until the voltage reached 3.0 V. Note that 0.2 C was a value of a current that caused a battery capacity (a theoretical capacity) to be completely discharged in 5 hours, and 0.025 C was a value of a current that caused the battery capacity to be completely discharged in 40 hours.

A film was thus formed on the surface of each of the positive electrode 21 and the negative electrode 22, and the state of the battery device 20 was therefore electrochemically stabilized. The secondary battery was thus completed.

### [Design of Capacity Ratio]

FIG. 6 illustrates a sectional configuration of a test secondary battery of a coin type. To fabricate the secondary battery of the laminated-film type described above, a capacity ratio was designed using the secondary battery of the coin type in accordance with the following procedure.

As illustrated in FIG. 6, the secondary battery of the coin type included a test electrode 61 placed inside an outer package cup 64, and included a counter electrode 62 placed inside an outer package can 65. The outer package cup 64 and the outer package can 65 each had a bowl shape. The test electrode 61 and the counter electrode 62 were stacked on each other with a separator 63 interposed therebetween, and the outer package cup 64 and the outer package can 65 were crimped to each other with a gasket 66 interposed therebetween. The test electrode 61, the counter electrode 62, and the separator 63 were each impregnated with the electrolytic solution, and the electrolytic solution had the configuration described above.

First, to design the capacity ratio, the positive electrode 21 was fabricated by a similar procedure except that the positive electrode active material layer 21B was formed only on one of the two opposed surfaces of the positive electrode current collector 21A. In addition, the negative electrode 22 was fabricated by a similar procedure except that the negative electrode active material layer 22B was formed only on one of the two opposed surfaces of the negative electrode current collector 22A.

Thereafter, the positive electrode 21 was used as the test electrode 61, and a lithium metal plate was used as the counter electrode 62 to fabricate a first secondary battery of the coin type. Further, the negative electrode 22 was used as the test electrode 61, and a lithium metal plate was used as the counter electrode 62 to fabricate a second secondary battery of the coin type.

Thereafter, the first secondary battery was charged to measure an electrical capacity, following which a charge capacity of the positive electrode 21 per thickness of the positive electrode active material layer 21B was calculated based on the measured electrical capacity and the thickness of the positive electrode active material layer 21B. Upon the charging, the first secondary battery was charged with a constant current of 0.1 C until a voltage reached 4.45 V, and was thereafter charged with a constant voltage of that value, 4.45 V, until a current decreased to 1/10. Note that 0.1 C was a value of a current that caused the battery capacity to be completely discharged in 10 hours.

Thereafter, the second secondary battery was charged to measure an electrical capacity, following which a charge capacity of the negative electrode 22 per thickness of the negative electrode active material layer 22B was calculated based on the measured electrical capacity and the thickness of the negative electrode active material layer 22B. Upon the charging, the second secondary battery was charged with a constant current of 0.1 C until a voltage reached 0 V, and was thereafter charged with a constant voltage of 0 V until a current decreased to 1/10.

Lastly, the capacity ratio was calculated based on the charge capacity of the positive electrode 21 and the charge capacity of the negative electrode 22. The capacity ratio was calculated based on the following calculation expression: capacity ratio=charge capacity of positive electrode 21/charge capacity of negative electrode 22.

To fabricate the secondary battery of the laminated-film type, a concentration and an application speed of each of the positive electrode mixture slurry and the negative electrode mixture slurry were so adjusted that the capacity ratio became 0.9.

### [Evaluation of Battery Characteristic]

The secondary batteries were each evaluated for each of a cyclability characteristic and a battery capacity characteristic as the battery characteristic in accordance with the following procedure, and the evaluation revealed the results presented in Tables 1 and 2.

### [Cyclability Characteristic]

First, the secondary battery was charged and discharged in an ambient temperature environment (at a temperature of 23° C.) to thereby measure a discharge capacity (a first-cycle discharge capacity). Thereafter, the secondary battery was repeatedly charged and discharged in the same environment until the number of cycles reached 100 to thereby measure the discharge capacity (a 100th-cycle discharge capacity). Lastly, a capacity retention rate serving as an index for evaluating the cyclability characteristic was calculated based on the following calculation expression: capacity retention rate (%)=(100th-cycle discharge capacity/first-cycle discharge capacity)×100.

Charging and discharging conditions for the first cycle were similar to those for stabilizing the secondary battery. Charging and discharging conditions for a second cycle and subsequent cycles were similar to those for the stabilization of the secondary battery, except that the current upon charging and the current upon discharging were each changed to 0.5 C. Note that 0.5 C was a value of a current that caused the battery capacity to be completely discharged in two hours.

### [Battery Capacity Characteristic]

The second secondary battery described above was charged and discharged to calculate a negative electrode capacity (mAh/g) serving as an index for evaluating the battery capacity characteristic.

Specifically, first, the second secondary battery was charged. In this case, the second secondary battery was charged with a constant current of 0.1 C until a voltage reached 0 V, and was thereafter charged with a constant voltage of 0 V until a current decreased to 1/10, as described above.

Thereafter, the second secondary battery was discharged to measure the discharge capacity (mAh). In this case, the second secondary battery was discharged with a constant current of 0.1 C until the voltage reached 1.5 V.

Lastly, the negative electrode capacity was calculated by dividing the discharge capacity by a weight (g) of the negative electrode active material. Note that values of the negative electrode capacity given in Tables 1 and 2 were values normalized with respect to the value of the negative electrode capacity in Example 4 assumed to be 100.

TABLE 1

| | Negative electrode active material | | | | | | | Negative electrode conductor | | | Capacity | Discharge |
|---|---|---|---|---|---|---|---|---|---|---|---|---|
| | Silicon- | | | | Weight | Negative electrode binder | | Fibrous | | | retention | capacity |
| | containing | Content | Carbon | Content | proportion | NVA | Content | carbon | Content | Absorption | rate | ratio |
| Example | material | (wt %) | material | (wt %) | (wt %) | polymer | (wt %) | material | (wt %) | peak | (%) | (—) |
| 1 | SiOₓ | 65.8 | MCMB | 28.2 | 70 | PNVA | 5 | SWCNT | 0.3 | Detected | 93 | 187 |
| 2 | SiOₓ | 47 | MCMB | 47 | 50 | PNVA | 5 | SWCNT | 0.3 | Detected | 94 | 235 |
| 3 | SiOₓ | 28.2 | MCMB | 65.8 | 30 | PNVA | 5 | SWCNT | 0.3 | Detected | 95 | 141 |
| 4 | SiOₓ | 9.4 | MCMB | 84.6 | 10 | PNVA | 5 | SWCNT | 0.3 | Detected | 95 | 100 |
| 5 | SiOₓ | 65.8 | MCMB | 28.2 | 70 | NVA-AALi | 5 | SWCNT | 0.3 | Detected | 93 | 183 |
| 6 | SiOₓ | 65.8 | MCMB | 28.2 | 70 | NVA-AANa | 5 | SWCNT | 0.3 | Detected | 92 | 184 |
| 7 | SiOₓ | 65.8 | MCMB | 28.2 | 70 | NVA-AAK | 5 | SWCNT | 0.3 | Detected | 92 | 185 |
| 8 | SiOₓ | 94 | — | — | — | PNVA | 5 | SWCNT | 0.3 | Detected | 90 | 270 |
| 9 | Si | 94 | — | — | — | PNVA | 5 | SWCNT | 0.3 | Detected | 85 | 709 |
| 10 | SiTi_{0.01} | 94 | — | — | — | PNVA | 5 | SWCNT | 0.3 | Detected | 89 | 267 |
| 11 | SiOₓ | 65.1 | MCMB | 27.9 | 70 | PNVA | 5 | SWCNT | 0.3 | Detected | 95 | 187 |
| | | | | | | SBR | 1 | | | | | |
| 12 | SiOₓ | 65.1 | MCMB | 27.9 | 70 | PNVA | 5 | SWCNT | 0.3 | Detected | 94 | 187 |
| | | | | | | PI | 1 | | | | | |
| 13 | SiOₓ | 65.1 | MCMB | 27.9 | 70 | PNVA | 5 | SWCNT | 0.3 | Detected | 94 | 187 |
| | | | | | | CMCN | 1 | | | | | |

TABLE 2

| | Negative electrode active material | | | | | Negative electrode | | Negative electrode conductor | | | Capacity | Discharge |
|---|---|---|---|---|---|---|---|---|---|---|---|---|
| | Silicon- | | | | Weight | binder | | Fibrous | | | retention | capacity |
| Comparative | containing | Content | Carbon | Content | proportion | NVA | Content | carbon | Content | Absorption | rate | ratio |
| example | material | (wt %) | material | (wt %) | (wt %) | polymer | (wt %) | material | (wt %) | peak | (%) | (—) |
| 1 | SiOₓ | 65.8 | MCMB | 28.2 | 70 | PAA | 5 | SWCNT | 0.3 | Undetected | 52 | 181 |
| 2 | SiOₓ | 65.8 | MCMB | 28.2 | 70 | PAA | 5 | SWCNT | 0.3 | Detected | 65 | 179 |
| 3 | SiOₓ | 65.8 | MCMB | 28.2 | 70 | PNVA | 5 | SWCNT | 0.3 | Undetected | 60 | 184 |
| 4 | SiOₓ | 9.4 | MCMB | 84.6 | 10 | PNVA | 5 | SWCNT | 0.3 | Detected | 95 | 100 |
| 5 | SiOₓ | 9.4 | MCMB | 84.6 | 10 | PAA | 5 | SWCNT | 0.3 | Undetected | 95 | 100 |
| 6 | SiOₓ | 28.2 | MCMB | 65.8 | 30 | PAA | 5 | SWCNT | 0.3 | Undetected | 70 | 138 |

As indicated in Tables 1 and 2, the capacity retention rate varied greatly depending on the configuration of the negative electrode binder and the physical property of the negative electrode conductor.

In the following, used as a comparison reference was a capacity retention rate in a case (Comparative example 1) where the negative electrode binder included no N-vinylacetamide polymer and where no absorption peak P (having the half-width of 10 cm⁻¹ or greater) was detectable based on the analysis of the negative electrode conductor (the fibrous carbon material) by the Raman spectroscopy.

When the negative electrode binder included no N-vinylacetamide polymer but the absorption peak P was detectable based on the analysis of the negative electrode conductor by the Raman spectroscopy (Comparative example 2), the capacity retention rate slightly increased. In this case, an increase rate of the capacity retention rate was 25%.

When the negative electrode binder included the N-vinylacetamide polymer but no absorption peak P was detectable based on the analysis of the negative electrode conductor by the Raman spectroscopy (Comparative example 3), the capacity retention rate slightly increased. In this case, an increase rate of the capacity retention rate was about 15%.

Based on the above, the capacity retention rate was expected to slightly increase when the negative electrode binder included the N-vinylacetamide polymer and the absorption peak P was detectable based on the analysis of the negative electrode conductor by the Raman spectroscopy. In this case, the increase rate of the capacity retention rate was expected to be about 40% (=25%+15%).

In fact, however, the obtained result was different from the above-described expectation. Specifically, when the negative electrode binder included the N-vinylacetamide polymer and the absorption peak P was detectable based on the analysis of the negative electrode conductor by the Raman spectroscopy (Example 1), the capacity retention rate markedly increased. In this case, the increase rate of the capacity retention rate was about 79%, which corresponded to about twice the expected increase rate (=about 40%).

This allowed a markedly high capacity retention rate to be obtained also when the kind and the composition of the negative electrode active material were changed (Examples 2 to 13).

In particular, when the negative electrode binder included the N-vinylacetamide polymer and the absorption peak P was detectable based on the analysis of the negative electrode conductor by the Raman spectroscopy (Examples 1 to 13), the following series of tendencies were obtained.

Firstly, when the single-walled carbon nanotube was used as the negative electrode conductor (the fibrous carbon material), a sufficiently high capacity retention rate was obtained. Secondly, such a sufficiently high capacity retention rate was obtained independently of the kind (the homopolymer of N-vinylacetamide or the copolymer of N-vinylacetamide) of the negative electrode binder (the N-vinylacetamide polymer). Thirdly, when both the silicon-containing material and the carbon material were used as the negative electrode active material, the capacity retention rate further increased, as compared with when only the silicon-containing material was used as the negative electrode active material. Fourthly, when both the silicon-containing material and the carbon material were used as the negative electrode active material, if the weight proportion was 30 wt % or higher, the negative electrode capacity further increased while the capacity retention rate remained high.

Further, it was confirmed that the capacity retention rate was improved by adding the styrene-butadiene rubber (SBR), polyimide (PI), or the carboxymethyl cellulose salt (CMCN) as the other negative electrode binder, in addition to the N-vinylacetamide polymer (Examples 11 to 13).

Based on the results presented in Tables 1 and 2, when: the negative electrode 22 included the negative electrode active material (the silicon-containing material), the negative electrode binder (the N-vinylacetamide polymer), and the negative electrode conductor (the fibrous carbon material); and the absorption peak P detectable based on the analysis of the negative electrode conductor by the Raman spectroscopy had the half-width HW of 10 cm 1 or greater, a high capacity retention rate was obtained. The cyclability characteristic thus improved. Accordingly, it was possible to achieve a secondary battery having a superior battery characteristic.

Although the present technology has been described above with reference to one or more embodiments including Examples, the configuration of the present technology is not limited thereto, and is therefore modifiable in a variety of ways.

Specifically, the description has been given of the case where the secondary battery has a battery structure of the laminated-film type or the coin type. However, the battery structure of the secondary battery is not particularly limited, and may be, for example, of a cylindrical type, a prismatic type, or a button type.

Further, the description has been given of the case where the battery device has a device structure of a wound type. However, the device structure of the battery device is not particularly limited, and the device structure may be, for example, of a stacked type or a zigzag folded type. In the stacked type, the positive electrode and the negative electrode are stacked on each other. In the zigzag folded type, the positive electrode and the negative electrode are folded in a zigzag manner.

Further, although the description has been given of the case where the electrode reactant is lithium, the electrode reactant is not particularly limited in kind. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other effect.

Note that the present technology may have any of the following configurations according to an embodiment.

<1>

A secondary battery including:
a positive electrode;
a negative electrode including a negative electrode active material, a negative electrode binder, and a negative electrode conductor; and
an electrolytic solution, in which
the negative electrode active material includes a silicon-containing material,
the negative electrode binder includes an N-vinylacetamide polymer,
the negative electrode conductor includes a fibrous carbon material,
based on an analysis of the negative electrode conductor by Raman spectroscopy, an absorption peak is detectable within a range of a Raman shift of greater than or equal to 120 reciprocal centimeters and less than or equal to 300 reciprocal centimeters, and
the absorption peak has a half-width of 10 reciprocal centimeters or greater.
   <2>

The secondary battery according to <1>, in which the fibrous carbon material includes a single-walled carbon nanotube.

<3>

The secondary battery according to <1> or <2>, in which the negative electrode active material further includes a carbon material.

<4>

The secondary battery according to <3>, in which a proportion of a weight of the silicon-containing material to a sum of the weight of the silicon-containing material and a weight of the carbon material is 30 weight percent or higher.

<5>

The secondary battery according to any one of <1> to <4>, in which the secondary battery includes a lithium-ion secondary battery.

<6>

A negative electrode for a secondary battery, the negative electrode including:
a negative electrode active material;
a negative electrode binder; and
a negative electrode conductor, in which
the negative electrode active material includes a silicon-containing material,
the negative electrode binder includes an N-vinylacetamide polymer,
the negative electrode conductor includes a fibrous carbon material,
based on an analysis of the negative electrode conductor by Raman spectroscopy, an absorption peak is detectable within a range of a Raman shift of greater than or equal to 120 reciprocal centimeters and less than or equal to 300 reciprocal centimeters, and
the absorption peak has a half-width of 10 reciprocal centimeters or greater.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode including a negative electrode active material, a negative electrode binder, and a negative electrode conductor; and
an electrolytic solution, wherein
the negative electrode active material includes a silicon-containing material,
the negative electrode binder includes an N-vinylacetamide polymer,
the negative electrode conductor includes a fibrous carbon material,
based on an analysis of the negative electrode conductor by Raman spectroscopy, an absorption peak is detectable within a range of a Raman shift of greater than or equal to 120 reciprocal centimeters and less than or equal to 300 reciprocal centimeters, and
the absorption peak has a half-width of 10 reciprocal centimeters or greater.

2. The secondary battery according to claim 1, wherein the fibrous carbon material includes a single-walled carbon nanotube.

3. The secondary battery according to claim 1, wherein the negative electrode active material further includes a carbon material.

4. The secondary battery according to claim 3, wherein a proportion of a weight of the silicon-containing material to a sum of the weight of the silicon-containing material and a weight of the carbon material is 30 weight percent or higher.

5. The secondary battery according to claim 1, wherein the secondary battery comprises a lithium-ion secondary battery.

6. A negative electrode for a secondary battery, the negative electrode comprising:
a negative electrode active material;
a negative electrode binder; and
a negative electrode conductor, wherein
the negative electrode active material includes a silicon-containing material,
the negative electrode binder includes an N-vinylacetamide polymer,
the negative electrode conductor includes a fibrous carbon material,
based on an analysis of the negative electrode conductor by Raman spectroscopy, an absorption peak is detectable within a range of a Raman shift of greater than or equal to 120 reciprocal centimeters and less than or equal to 300 reciprocal centimeters, and
the absorption peak has a half-width of 10 reciprocal centimeters or greater.
